(19) United States
(12) Patent Application Publication
(10) Pub. No.: US 2010/0211486 A1
(43) Pub. Date: Aug. 19, 2010

(54) Time capturing system and method

(75) Inventors: Alexandr Abrashkin, Columbia, SC (US); Thorben Primke, Columbia, SC (US)

Correspondence Address: MCNAIR LAW FIRM, P.A., P.O. BOX 447, GREENVILLE, SC, 29602-0447, US

(73) Assignee: iTekka, Inc., Columbia, SC (US)

(21) Appl. No.: 12/378,637

(22) Filed: Feb. 18, 2009

(51) Int. Cl. G06Q 30/00; G06Q 10/00; G06Q 50/00

(52) U.S. Cl. 705/32; 705/34

(57) ABSTRACT

This invention is directed to a time capturing system and method for automatically tracking time spent by a service provider, gathering information necessary to create an invoice and using that time to automatically create a pre-bill that can be reviewed by the user and used to generate an invoice.

### BACKGROUND OF THE INVENTION

This invention is directed to a time capturing system that automatically tracks time spent by a service provider that bills the client by the hour and whose invoices are based upon the time spent rendering the contracted for services.

Typically the service provider is required to record every billable activity throughout the workday by recording the amount of time that was spent on the activity and providing a written description of the activity. The service provider must then associate the time and description with the client for whom the activities are being performed. The record of the activity is then used to prepare a pre-bill that will be returned to the timekeeper for correction and final approval before the pre-bill is converted into a final invoice that is sent to a client. As simple as this task may seem, it is estimated that service providers who bill by the hour, also known as timekeepers, spend approximately 20 minutes a day engaging in time keeping activities such as taking notes regarding their activities and filling in time sheets. This can result in approximately 80 hours per year that the timekeeper is forced to engage in timekeeping activities rather than activities that can be billed to a client. Thus, it is advantageous to provide a time capturing system that minimizes the amount of time and effort that must be spent by the timekeeper in relation to timekeeping activities.

Several systems for aiding the timekeeper to keep track of his or her time exist. A common feature for nearly all of these solutions is a pop-up timer that can be opened and available on a computer all day long. This feature allows a user to keep track of his or her time and to immediately enter details of each task as it is completed. The use of a pop-up timer, however, has its deficiencies as it requires that the user monitor the timer to ensure that the timer has been activated and deactivated at the appropriate times. Additionally, the timekeeper is required to manually fill-in the billing information necessary to bill the client for the activities performed, as well as a description of the activities performed.

The existing timekeeping systems also include a multi-step process for preparing a final invoice that may be sent to the client. First, the timekeeper must create and submit his or her time entries, whether electronically or on paper. Second, these time entries are used to create a pre-bill that is a draft version of the final invoice. A paper copy of these pre-bills is typically distributed to each timekeeper for correction and review. The corrected pre-bills are then used to generate a final invoice that is sent to the client.

Accordingly, an object of the present invention is to provide a time capturing system that automatically collects, from multiple sources, data that is necessary for preparing time entries and thus final invoices, thereby, reducing the amount of time and human interaction involved in timekeeping activities.

Another object of the present invention is to provide a time capturing system that reduces the amount of paper that is required to create final invoices according to the time entries submitted by the timekeeper.

### SUMMARY OF THE INVENTION

The above objectives are accomplished according to the present invention by providing a system comprising an add-on computer program for being installed on a portable computing device that, when executed by the portable computer device, causes the portable computer device to perform the method of receiving a call initiation instruction from the portable computing device wherein the call initiation instruction represents the initiation of a phone call, activating a timer upon receiving the call initiation instruction, receiving a call termination instruction from the portable computing device wherein the call termination instruction represents the termination of a phone call, deactivating the timer upon receiving the call termination instruction and determining the duration of the call; a server having a database embodied in the server wherein the database includes billing information for each of the user's clients, the server being in communication with the portable computing device and an invoicing server; a server computer program installed in the server that when executed by the server causes the server to perform the method of receiving the billing information from the invoicing server and updating the database with the billing information, receiving caller identification information from the portable computing device wherein the caller identification information represents the identification of a caller, receiving billing information associated with the caller identification information from the database, receiving the duration of the call from the portable computing device, creating a time entry according to the billing information associated with the client identification information and the duration of the call, and transmitting the time entry to the invoicing server; whereby, the time capturing system automatically creates the time entry tracking the time the user spends speaking to another individual via the portable computing device, thus, reducing the amount of time and human interaction necessary to create the time entry.

In a further embodiment, the add-on computer program can further perform the method of receiving the time entry from the server and presenting the time entry to the user on the portable computing device for review. Preferably, the add-on computer program performs the method of receiving an approval of the time entry; and server computer program performs the method of receiving the time entry from the portable computing device upon approval and transmitting the time entry to the invoicing server.

In a further embodiment, the server computer program performs the method of receiving a pre-bill from the invoicing server and transmitting the pre-bill to the portable computing device; and the add-on computer program performs the method of receiving the pre-bill from the server and presenting the pre-bill to the user on the portable computing device for review. Preferably, the add-on computer program performs the method of receiving an approval of the pre-bill; and the server computer program performs the method of receiving the pre-bill from the portable computing device upon approval and sending the pre-bill to the invoicing server.

In a further embodiment, the add-on computer program performs the method of creating a copy of the database and storing the copy of the database in the portable computing device; and the server computer program performs the method of receiving the billing information from one of the portable computing device and the database. Preferably, the server computer program performs the method of receiving billing information from the invoicing server when billing information is not retrievable from one of the portable computing device and the database.

In yet another embodiment, a system is provided that comprises a server for communicating with an invoicing server and a workstation wherein the workstation includes an electronic calendar; a database embodied in the server, wherein the database includes billing information for each of the user's clients; a server computer program installed in the server that, when executed by the server, causes the server to perform the method of receiving the billing information from the invoicing server and updating the database with the billing information, receiving event information from a scheduled event associated with the electronic calendar wherein the event information includes a start time and an end time of a scheduled event and the subject of the scheduled event, determining whether the start time of the scheduled event has elapsed, receiving client information from the scheduled event, receiving billing information from the database according to the client information, creating a time entry according to the event information and the billing information associated with the client information, and transmitting the time entry to the invoicing server; whereby the time capturing system automatically creates the time entry tracking the time spent by the user attending the scheduled event, thus, reducing the amount of time and human interaction necessary to create the time entry. Preferably, client identification information represents information regarding the identity of the individuals attending the scheduled event.

In a further embodiment, the server computer program performs the method of receiving a pre-bill from the invoicing server and presenting the user with the pre-bill for review. Preferably, the server computer program performs the method of receiving an approval of the pre-bill from the user and transmitting the approved pre-bill to the invoicing server.

In a further embodiment, the server computer program performs the method of determining whether the billing information associated with the client information is available from the scheduled event, receiving the billing information associated with the client information if the information associated with the client information is available from the scheduled event and receiving the billing information associated with the client identification information from the database if the billing information associated with the client identification information is not available from the scheduled event. Preferably, the server computer program performs the method of determining whether the billing information associated with the client information is available from one of the scheduled event and the database and receiving the billing information associated with the client information from the user if the billing information associated with the client information is not available from one of the scheduled event and the database.

In a further embodiment, the server computer program performs the method of determining whether the billing information associated with the client information is available from the scheduled event and receiving the billing information associated with the client information from the user if the billing information associated with the client information is not available from the scheduled event.

In a yet another embodiment, a system is provided that comprises a server in communication with a third party computer program and an invoicing server and having a database embodied in the server, wherein the database includes billing information for each of the user's clients; a server computer program installed on the server that when executed by the server causes the server to perform the method of receiving the billing information from the invoicing server and updating the database with the billing information, activating a timer upon accessing the third party computer program, detecting when user activity begins with respect to the third party computer program, detecting when user activity has ceased with respect to the third party computer program, determining an elapsed time during which user activity began and ceased with respect to the third party computer program, receiving client identification information from the third party computer program, receiving billing information associated with the client identification information from the third computer program, creating a time entry according to the elapsed time and the billing information associated with the client identification information, and transmitting the time entry to the invoicing server; and, whereby the time capturing system automatically creates the time entry, reducing the amount of time and human intervention necessary to prepare the time entry.

In a further embodiment, the server computer program performs the method of receiving instruction from the user as to whether the elapsed time during which user activity had ceased with respect to the third party computer program should be billed to a client and modifying the elapsed time during which user activity had ceased. Preferably, the server computer program performs the method of receiving a pre-bill from the invoicing server, presenting the user with the pre-bill for review, receiving an approval of the pre-bill from the user and transmitting the approved pre-bill to the invoicing server.

In a further embodiment, the server computer program performs the method of determining whether the billing information associated with the client identification information is available from the third party computer program, receiving the billing information associated with the client identification information from the third party computer program if the billing information associated with the client identification information is available from the third party computer program and receiving the billing information associated with the client identification information from the database if the billing information associated with the client identification information is not available from the third party computer program. Preferably, the server computer program performs the method of determining whether the billing information associated with the client identification information is available from one of the third party computer program and the database and receiving the billing information associated with the client identification information from the user if the billing information associated with the client identification information is not available from one of the third party computer program and the database.

In a further embodiment, the server computer program performs the method of determining whether the billing information associated with the client identification information is available from the third party computer program and receiving the billing information associated with the client identification information from the user if the billing information associated with the client identification information is not available from the third party computer program.

### DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a schematic showing the communication methods of the present invention;

FIG. 2 is a schematic showing the data flow of a first embodiment of the present invention;

FIG. 3 is a schematic showing the data flow of a first embodiment of the present invention;

FIG. 4 is a schematic showing the data flow of a third embodiment of the present invention;

FIG. 5 is a flowchart of the operations of a first embodiment of the present invention;

FIG. 6 is a flowchart of the operations of a second embodiment of the present invention;

FIG. 7 is a flowchart of the operations of a third embodiment of the present invention; and

FIG. 8 is a flowchart of the operations of a fourth embodiment of the present invention.

### DESCRIPTION OF A PREFERRED EMBODIMENT

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium but may span several computers or storage mediums. The terms “host” and “server” may be hardware, software, or combination of hardware and software that provides the functionality described herein. This invention thereby allows multiple users, being geographically dispersed, to interact with data relating to physical characteristics of manufactured products using a system that ensures the precise and accurate conveyance of such information.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus providing steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

Referring now in more detail to the drawings, the invention will now be described in more detail.

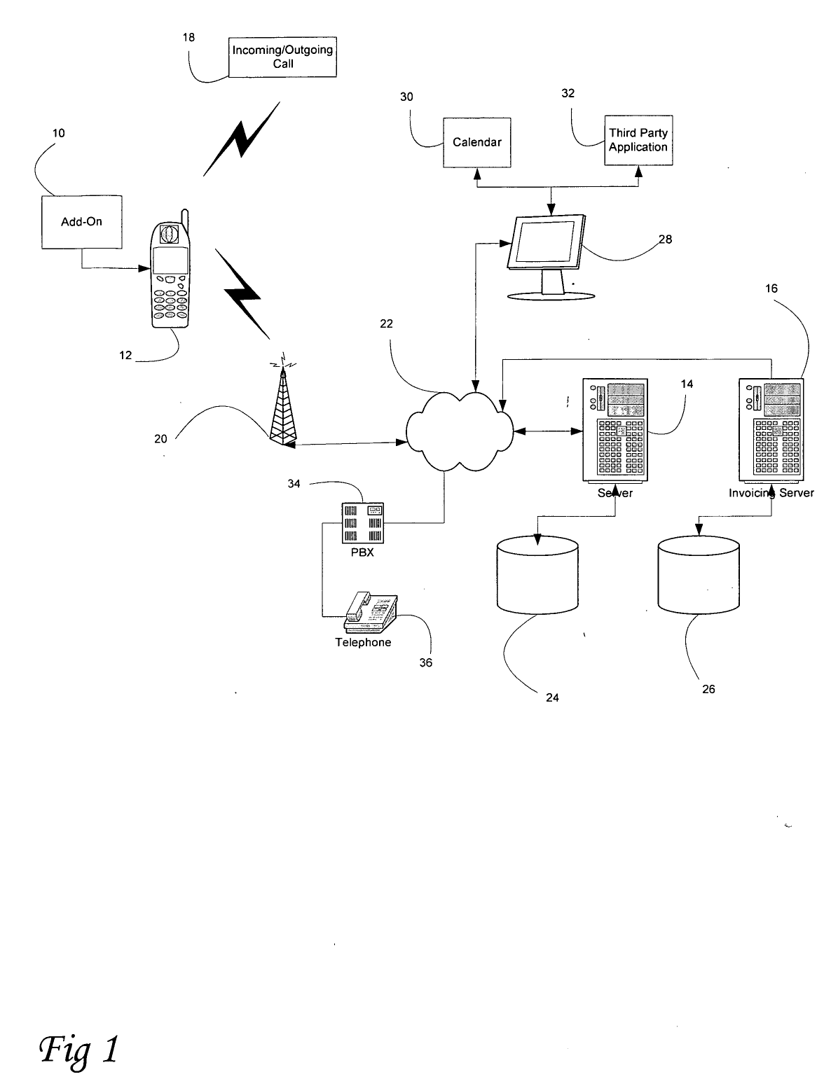

Referring now to FIG. 1, the schematic showing the basic operation of the invention is shown. The invention comprises add-on computer software 10 that can be downloaded onto a portable computing device (“PCD”) such as a portable phone 12, as well as a computer software that resides on a server 14 that allows the server to communicate with the PCD and in some embodiments, an invoicing server 16, so that information may be gathered from the PCD 12 and used to create a time entry that can be included on a pre-bill containing one or more time entries pertaining to a particular client, which will be used to create an invoice.

The server can be any piece of hardware on which computer readable instructions, such as computer software, can reside. The PCD 12 can include any device such as a cellular phone, a PDA, a laptop or other electronics that can communicate via a network. Invoicing server 16 is much like server 14 except that it hosts billing and/or accounting applications such as CMS Open, Standard Time, Harvest, Abacus Law, Responsive TimeLogger, Dovico, TimeSlips, Amicus Accounting, Time Matters, Quicken, QuickBooks, Excel or other applications known in the art. While the illustrated embodiment shows the use of several servers 14 & 16 and a network 22 so that multiple users can use the invention, in alternate embodiments all of the necessary software and databases could reside on a single piece of hardware such as the PCD 12 or workstation 28, thus alleviating the need for separate servers and a network. Further, the computer readable instructions could reside on invoicing server 16 rather than server 14, thus alleviating the need for multiple servers.

Once the add-on computer program 10 is downloaded to the PCD 12, the PCD may take an incoming call 18, or make an outgoing phone call. The call initiation notice that the add-on computer readable software receives in response to the incoming or outgoing phone call actuates the software so that it begins automatically gathering data that can be used to create a time entry. Once the add-on software 10 receives a call termination notification in response to the termination of the call, the PCD 12 transmits information such as the call duration and caller identification information to a network 22 through means generally known in the art 20. In the shown embodiment, the PCD is a mobile phone and transmits the information wirelessly.

The time capturing software residing on server 14 receives the call duration and caller identification information from the PCD 12 through the network 22. The server 14 may receive the call duration and caller identification information in one of several manners. In one embodiment, the PCD 12 transmits the information in response to a request sent to it from software residing on server 14. However, in alternate embodiments, the add-on computer software 10 residing on the PCD includes instructions for transmitting the information to the server. In yet another embodiment, the software residing on server 14, includes instructions for searching the database on the PCD 12 to retrieve the information. For purposes of the patent, it should be known that when the server “receives” information, it may be through any of the above mentioned methods. The PCD 12 may also “receive” information in the same manner so that the server 14 may transmit the information to the PCD in response to a request for the information sent by add-on software 10. Alternately, the software residing on the server may include instructions to transmit the information to the PCD or the add-on computer software 10 may include instructions for searching a database residing on the server to retrieve the information. It should be known that when the PCD “receives” information, it may do so through any of the above methods.

The server 14 uses the caller identification information to receive the billing information from a database 24 that includes billing information and resides within server 14 or a database 26 that includes billing information and resides within the invoicing server 16. Billing information can include client numbers, matter numbers, identification information or any other information that is associated with clients that allows the user to track his or her time and create invoices for the time spent working for the client. Once the server has received the billing information and the call duration information, server 14 automatically creates a time entry according to such information. The PCD 12 receives the time entry through the network 22. Upon receiving user approval of the time entry, the PCD may transmit the approved time entry through the network 22 to an invoicing server 16. The invoicing server can then create a pre-bill according to the approved time entry that can received by the PCD. Once the user has approved the pre-bill, the pre-bill can be transmitted through the network 22 to the invoicing server 16 where a final invoice can be created.

The computer software residing on server 14 also allows the server to communicate with a land-line telephone system 36 that is connected via a network. In the shown embodiment, the telephone system is connected to the network by a Private Branch Exchange (“PBX”) 34. In alternate embodiments, however, the telephone system could be connected to the network via phone call management server that has the appropriate software to direct the phone calls to the correct phones connected to the network. Typically, voice over internet protocol systems are connected to a network via a server having the call management software. Other analog systems are typically connected to the network via the PBX 34. In either case, the system allows time to be captured from such a phone system in much the same manner as time is captured from the PCD 12. Once an incoming or outgoing call is initiated, the server 14 receives a call initiation notification from the PBX 34 or the call management server (not shown), which actuates the software so that it begins automatically gathering data that can be used to create a time entry. Once the server 14 receives a call termination notification in response to the termination of the incoming or outgoing call, the server receives information such as the call duration and caller identification information through the network 22. The software residing on the server uses this information to create a pre-bill in the same manner as described in association with the PCD. Depending on the type of display included on the telephone, the pre-bill may be transmitted to the user's telephone or to the user's workstation 28.

The computer software residing on server 14 also allows the server to communicate with a workstation 28 on which an electronic calendar 30 and/or one or more third party applications 32 reside. The workstation can be a computer or any other computing devices known in the art, including a PCD. The computer software residing on server 14 allows the server to communicate with the electronic calendar 30, a third party application 32 or the server upon which the electronic calendar or the third party applications reside to receive information that is necessary to create a time entry that can be approved by the user.

With respect to the electronic calendar 30, the server receives the event information and client identification information from the electronic calendar. A time entry is then created and received by the workstation 28 or other device on which the electronic calendar is being used so that the time entry can be approved by the user. Once the time entry has been approved, the time entry can be transmitted via the network 22 to the invoicing server which in turn creates a pre-bill that may be received by the workstation and approved by the user. Once the pre-bill has been approved, the approved pre-bill can be transmitted via network 22 to the invoicing server 16, at which point the invoicing server can create a final invoice that can be sent to the client.

With respect to the third party application, the software residing on the server 14 may receive the duration of user activity with respect to the third party application as well as the client identification and/or billing information and use such information to create a time entry and pre-bill in the same manner as discussed in association with the electronic calendar. Once the pre-bill has been approved, the invoicing server can create a final invoice that can be sent to the client.

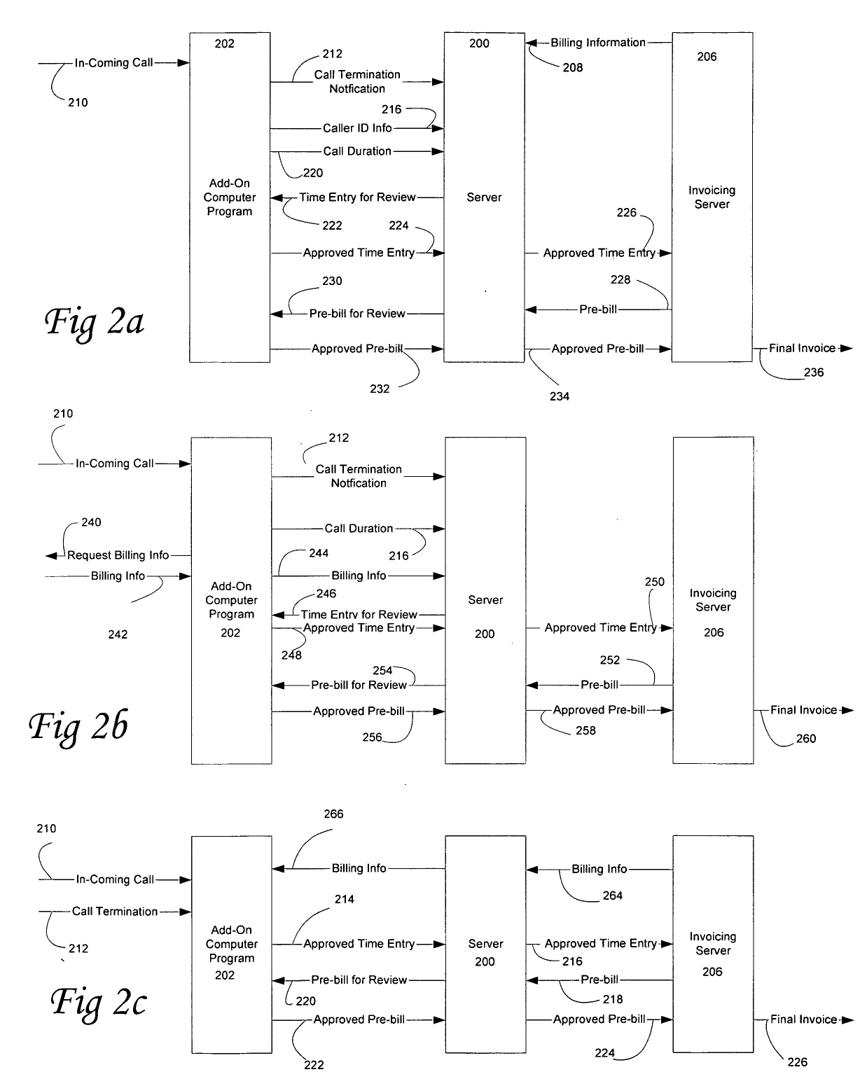

Referring now to FIGS. 2a-c, the flow of data that occurs during the operation of the invention when used in association with a PCD will be explained in further detail. In the shown embodiment three pieces of hardware are used, the PCD, on which the add-on computer software 202 resides, the server 200 on which the time capturing software resides and the invoicing server. While the shown embodiment shows the flow of data during operation of the invention with respect to a PCD, the flow of data is generally the same as when a land-line telephone is used. The one material difference between the land-line and the PCD is that with the land-line, it is unnecessary to download any add-on computer software 202 onto the telephone. Instead, the time capturing software residing on the server 14 receives the information necessary to create a time entry directly from the PBX. Otherwise, the flow of data is essentially the same for either embodiment.

Referring now to FIG. 2a, the server 200 receives the billing information at 208 from the invoicing server 206. Once the server 200 receives the billing information, it creates a database of the billing information. Once the server 200 has created a database of the billing information, and the add-on computer program has been downloaded to the PCD 202, the system is ready to automatically record time and create time entries based on the time spent on taking a phone call. At 210, a call notification corresponding to an incoming or outgoing phone call causes the PCD to activate a timer so that the duration of the call may be recorded. While the embodiments shown in FIGS. 2a-c, show that the call notification is created by an incoming call, the call notification can be created by an outgoing phone call as well so that the time spent on incoming as well as outgoing phone calls can be used to automatically create a time entry.

Once the incoming or outgoing phone call is terminated, a call termination notification causes the timer to be deactivated and the server 200 receives the call termination notification at 212. The server receives caller identification information from the PCD at 216. The server may, either simultaneously or subsequently, receive the call duration from the phone at 220. The server then uses the caller identification information to receive the billing information that is associated with the caller identification information from the database residing on the server 200. With the call duration and the billing information associated with the client, the server 200 creates a time entry and the PCD receives the time entry at 222 so that it may be reviewed by the owner. Once the user has reviewed and approved the time entry, the server receives the approved time entry at 224. The server then transmits the approved time entry 226 to the invoicing server 206 so that a pre-bill can be created by the invoicing server. As is true with all of the embodiments disclosed herein or shown in a drawing, the embodiments could include an alternate configuration where the add-on computer software that resides on the PCD 202, could include instructions for communicating directly with the invoicing server 206. In this alternate embodiment, the PCD could receive or transmit information directly to the invoicing server 206 rather than indirectly through the server 200. Thus, the PCD 202 would have the ability to transmit the approved time entry directly to the invoicing server rather than transmitting it first to the server.

Once the invoicing server has created the pre-bill, the server 200 receives the pre-bill at 228. Upon receiving the pre-bill from the invoicing server, the PCD 202 receives the pre-bill at 230 so that the pre-bill can be reviewed and approved by the user. As discussed above, the add-on computer could also include instructions for receiving the pre-bill directly from the invoicing server 206 rather than receiving the pre-bill indirectly through the server 200. Once the PCD receives the pre-bill and the user has approved the pre-bill, the PCD transmits the approved pre-bill 232 to the server which then transmits the approved pre-bill at 234 to the invoicing server. However, in alternate embodiments, the add-on computer software could transmit the approved pre-bill directly to the invoicing server. Once the approved pre-bill has been transmitted to the invoicing server 206, the invoicing server creates a final invoice at 236 which can be sent to the client.

Referring now to FIG. 2b, an alternate embodiment where the billing information is received from the user rather than the invoicing server 206 is disclosed. This embodiment allows users to create time entries for new clients whose billing information has not yet been stored in either the server 200 or the invoicing server 206 by allowing the PCD 202 or the server 200 to receive the billing information from the user when such information is not available from a database on the PCD, server or invoicing server. At 210, the PCD 202 receives a call notification in response to an incoming or outgoing phone call which prompts the activation of a timer so that the duration of the call can be calculated. The PCD receives a call termination notification once the phone call has been terminated. The call termination notification causes the timer to be deactivated and the server receives the call termination notification at 212. Just as was shown in FIG. 2a, upon receiving the call termination notification, the server receives the call duration at 216. In this embodiment, there is no need to request the caller identification since the billing information will be received directly from the user. Therefore, the add-on software residing on the PCD requests the billing information from the user 240 and the PCD receives the billing information from the user at 242. The server 200 receives the billing information at 244.

With the call duration and the billing information associated with the client, the server creates a time entry and the PCD receives the time entry at 246 so that it may be reviewed by the user. Once the mobile phone receives the approved time entry from the user, the server receives the approved time entry at 248, which then prompts the server to transmit the approved time entry to the invoicing server at 250. As discussed above, the add-on computer program may include instructions allowing the PCD 202 to communicate directly with the invoicing server 206, thus alleviating the need to receive and/or transmit information to the invoicing server indirectly through the server 200. With the approved time entry, the invoicing server creates a pre-bill and the sever receives the pre-bill at 252 and the PCD receives the pre-bill at 254 so that the pre-bill may be reviewed and/or edited by the user. Once the user approves the pre-bill, the server receives the approved electronic pre-bill at 256 and transmits the approved pre-bill to the invoicing server at 258. Alternately, the PCD could transmit the pre-bill directly to the invoicing server. With the approved pre-bill, the invoicing server 206 creates a final invoice at 260 which can then be mailed to the client.

Referring now to FIG. 2c, in yet another embodiment, the billing information can be stored in a database on the mobile phone itself, thereby allowing the mobile phone to create the time entry. In this embodiment, the server 200 receives the billing information from the invoicing server 206 at 264. The PCD receives the billing information at 266. Alternately, the PCD could receive the billing information directly from the invoicing server. The add-on computer program then creates a database of the billing information on the PCD so that the billing information can be accessed directly from the PCD. At 210, the PCD receives a call notification in response to an incoming or outgoing phone call which activates a timer. Upon receiving the call termination notification at 212, the add-on software on the PCD 202 deactivates the timer and calculates the duration of the call. The add-on computer program then receives the caller identification from the PCD and uses that information to receive the billing information associated with that client from the database of billing information residing in the PCD. With the call duration and the billing information, the add-on computer program then creates a time entry that can then be reviewed and/or edited by the user. Once the PCD receives the approved time entry from the user, the server 200 receives the approved time entry at 214. The server then transmits the approved time entry to the invoicing server at 220. As discussed above, the software on the PCD could allow the PCD to transmit the time entry directly to the invoicing server. The invoicing server 206 uses the approved time entry to create a pre-bill and the server receives the pre-bill at 218 and the PCD receives the pre-bill at 220 so that it may be reviewed by the user. Upon receiving approval from the user, the server receives the approved pre-bill at 222 and transmits the approved pre-bill at 224 to the invoicing server. In turn, the invoicing server creates a final invoice according to the approved pre-bill at 226.

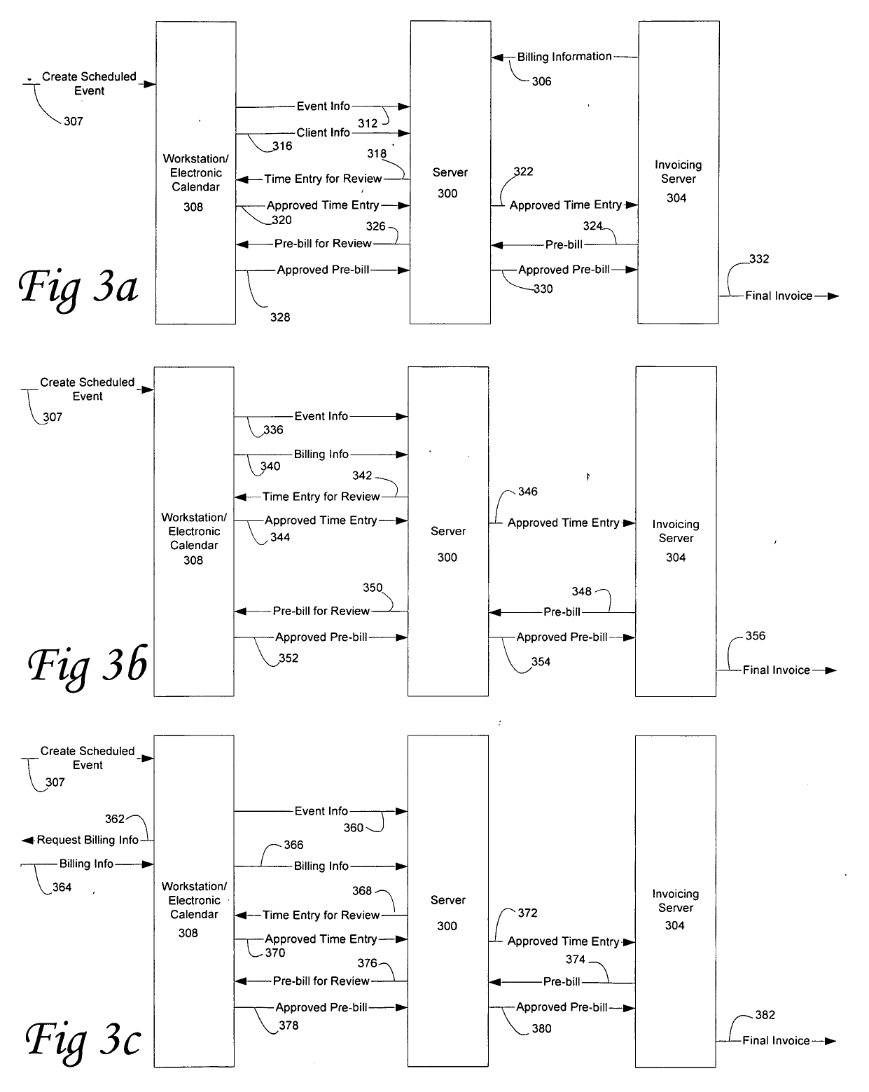

Referring now to FIG. 3a, another embodiment of the invention is disclosed where the computer software residing on the server 300 or the work station 308 can communicate with an invoicing server 304 and an electronic calendar to gather information from the electronic calendar and/or invoicing server to create a time entry which can be used to create a pre-bill and an invoice. The computer software which resides on server 300 causes the server to receive billing information from the invoicing server 304 at 306. The server then creates a database of all the billing information which resides on the server. The software allows the server 300 or the workstation 308 to communicate with the electronic calendar on a real-time basis so that when a user creates a scheduled event, the server and/or workstation can determine if that event has started. Once the scheduled start time has occurred, server receives the event information at 312 from the electronic calendar. The event information can include the time, location and duration of the scheduled event, the subject or description of the event and other information needed to create a time entry. The server may simultaneously or subsequently receive client information from the electronic calendar at 316. Client information can include the identity of individuals attending the scheduled event, the corporate representatives in attendance or the client associated with the scheduled event. With the client information, the server receives the billing information that is associated with the client or clients who are associated with the scheduled event from the database residing on the server. With the duration of the event, which may be obtained from the event information and the billing information, the server can then create a time entry which is received by the workstation at 318 for user review. Once the user has approved the entry, the server receives the approved time entry at 320 and transmits the approved time entry at 322 to the invoicing server.

Much like the embodiments described in FIGS. 2a-c, the computer program residing on the workstation 308 may allow the workstation to communicate directly with the invoicing server so that the workstation 308 may transmit and/or receive information directly to or from the invoicing server rather than indirectly through the server 300.

The invoicing server uses the time entry to create a pre-bill consisting of one or more time entries associated with that particular client. At 324, the server receives the pre-bill and the workstation receives the pre-bill at 326 so that it may be reviewed by the user. Once the user has reviewed and approved the pre-bill, the server receives the approved pre-bill at 328 and transmits the approved pre-bill to the invoicing server at 330. Alternatively, the workstation could transmit the approved pre-bill directly to the invoicing server. The invoicing server may then use the approved pre-bill to create a final invoice at 332 that may be sent to the client for payment.

Referring now to FIG. 3b, in at least one embodiment the billing information may be included in the scheduled event created by the user, thereby alleviating the need to receive that information from the invoicing server. Therefore, when the user creates a scheduled event at 307, the server 300 may determine if the scheduled start time has elapsed. If the start time has elapsed, the server 300 receives the event information from the electronic calendar at 336. Because the billing information is included in the scheduled event stored on the electronic calendar, there is no need to request the client identification information so that the billing information can be received from the server's database. Therefore, the server receives the billing information from the electronic calendar at 338. With the billing information and the duration of the event, which is obtained from the event information, the server creates a time entry and the workstation receives the time entry at 342 for review by the user. Once the user has approved the time entry, the server receives the time entry at 344 and transmits the approved time entry to the invoicing server at 346. The invoicing server creates a pre-bill according to one or more time entries for a particular client. The server then receives the pre-bill at 348; the workstation receives the pre-bill for user review at 350. Alternatively, the software residing on the workstation could allow the workstation to receive the pre-bill directly from the invoicing server. Once the user has reviewed the pre-bill, the server receives the approved pre-bill at 352 and transmits the approved pre-bill to the invoicing server at 354. However, the workstation could transmit the approved pre-bill directly to the invoicing server. The invoicing server may then use the approved pre-bill to create a final invoice at 356 that may be sent to the client to be paid.

Referring now to FIG. 3c, in yet another embodiment, the billing information may be requested directly from the user when the billing information is not available from the scheduled event, the database of billing information included on the server, or the invoicing server itself. This situation may arise, for example, when the scheduled event involves a new client whose billing information has not yet been input into the invoicing server. Therefore, when the electronic calendar 308 receives scheduled event created by the user at 307, the server and/or the workstation may determine whether or not the scheduled start time has occurred. If so, the server will receive the event information at 360. Because the billing information is not available from anywhere else, the billing information will be requested from the user at 362. The add-on computer software residing on the workstation can request the billing information from the user or the computer software residing on the server can prompt the workstation to request the billing information from the user. In either event, the user supplies the requested billing information at 364 and in turn, the server receives the billing information at 366.

With the event information and the billing information, the server can then create a time entry that will be received by the workstation at 368 for user review. Once the user has approved the time entry, the server receives the approved time entry at 370 and transmits the approved time entry at 372 to the invoicing server. Again, the time capturing software may allow the workstation to transmit the approved time entry directly to the invoicing server 304 rather than indirectly through the server 300.

With the approved time entry, the invoicing server can create a pre-bill that includes one or more time entries associated with the client and the server receives the pre-bill at 374 and the workstation receives the pre-bill at 376 to the workstation. However, the time capturing software residing on the electronic workstation could retrieve the pre-bill directly from the invoicing server. However, once the user has approved the pre-bill, the server receives the approved pre-bill at 378 and transmits the approved pre-bill to the invoicing server at 380. However, the workstation could transmit the approved pre-bill directly to the invoicing server without having to first transmit it to the server. Once the invoicing server has received the approved pre-bill, it may use the pre-bill to create a final invoice at 382, which may then be mailed to the client for payment.

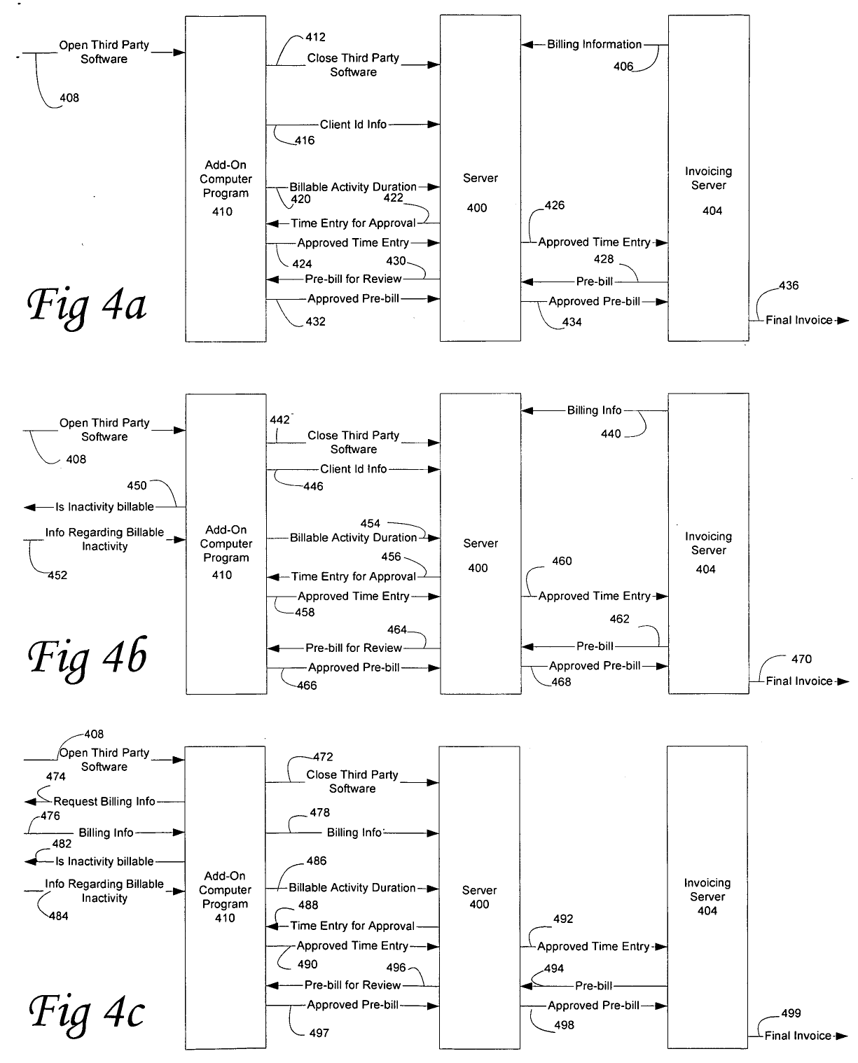

Referring now to FIG. 4, yet another embodiment allows information to be gathered from one or more third party applications such as email applications, word processing applications, or any other application that might be used during the course of providing client services. The invention may gather this information directly from the workstation or server on which the third party program resides. With this information, the system may then automatically create a time entry that will be submitted to the user for approval, and upon approval, used to create a pre-bill that includes one or more time entries associated with a particular client. The pre-bill may then be electronically reviewed and approved by the user and then used to create a final invoice which may be sent to the client.

Referring now to FIG. 4a, at 406 the server 400 receives billing information from the invoicing server 404. Server then creates a database that includes all of the billing information. Once the user opens the third party application at 408, the add-on computer program residing on workstation 410 and/or server activates a timer so that the duration that the user is working on the third party application can be calculated. When the user closes the third party software, the server receives an indication that the third party software has been closed at 412. The server then receives the client identification information from the third party application at 416. The client identification information can include the identification of the client, such as the name, the company name or the address of the client and may be obtained from the third party software in a variety of methods. One such method is to simply scan the input fields to determine if the user has input such information. Using a word processing application for example, the add-on computer software may scan the information that is used to save the document to see if the document has been saved in association with a particular client. If such information does not exist in any of the input fields associated with the document, the add-on computer software may then scan the text of the document to search for key words that match or otherwise correspond to the billing information stored in the database on server. For example, if the user has typed a letter, the software may scan the recipient field to determine if the recipient matches information associated with a particular client or matter.

While the embodiments shown if FIGS. 4a & b illustrate the software receiving the client identification information after the third party application has been closed, one skilled in the art would recognize that the server could just as easily receive client identification information after the third party software has been opened but before such software has been closed. In either case, the server 400 receives the client identification information from the third party software via the workstation or server on which such software resides.

Once the server has received the client information, it may subsequently or simultaneously receive the billable activity duration at 420 that was calculated by the timer. The server uses the client identification information to receive the billing information associated with the client from the database of billing information that resides on the server. With the billing information and the billable activity duration, the server may then create a time entry which may be received by the workstation at 422 so that the time entry may be approved by the user. Once the user has approved the time entry, the server receives the approved time entry at 424 and transmits the approved time entry to the invoicing server at 426. However, in alternate embodiments, the computer program may include instructions for transmitting the approved time entry directly from the workstation to the invoicing server without first transmitting the approved time entry to the server 400.

With the approved time entry, the invoicing server 404 creates a pre-bill that is received by the server at 428 and then by the workstation for review by the user at 430. Once the user has approved the pre-bill, the server receives the approved pre-bill at 432 and transmits the approved pre-bill to the invoicing server at 434. Again, the computer program may include instructions for allowing workstation 410 to transmit the approved pre-bill directly to the invoicing server 404 without first transmitting the approved pre-bill to the server 400. With the approved pre-bill, the invoicing server may then create a final invoice at 436 and the final invoice may be sent to the client for payment.

Referring now to FIG. 4b, an alternate embodiment is disclosed whereby the time capturing program includes instructions for determining periods of inactivity with respect to the third party application and determining whether such periods of inactivity are billable to the client. Therefore, at 440, the server 400 receives the billing information from the invoicing server 404 and creates a database of the billing information that resides on the server. As with the previous embodiment disclosed in FIG. 4a, once the client opens the third party software at 408, the time capturing program activates an activity timer to determine the activity duration. In at least one embodiment, such instructions include instructions for detecting keystrokes, or a lack thereof, on the keyboard. When the keystrokes terminate or cease for a predetermined period of time, the activity timer is deactivated until such point in time that the keystrokes resume again. The inactivity timer is simultaneously activated to determine the duration of the inactive period. To determine the total amount of billable time, the software adds the total activity time together with any period of inactivity that is determined to be billable to the client. In one embodiment, any period of inactivity can automatically be deducted or otherwise omitted from the total billable activity time. In other embodiments, the program may request the user to determine whether such periods of inactivity are billable at 450.

In another embodiment, the activity timer may continue to run for the entire time that the third party application is open. In this embodiment, the inactivity time is activated once the keystrokes terminate or cease for a predetermined period of time. The total billable time can then be calculated by subtracting the total duration of inactivity that is determined not to be billable to the client. As with the previously discussed embodiment, the duration of inactivity can be automatically subtracted from the total billable activity time or the duration of inactivity can be subtracted upon receiving instructions from the user that such time is not billable to a client.

Regardless of the method used to calculate the total billable activity time, an alternate embodiment of the invention includes instructions for determining whether the user has toggled off of the third party application. For example, if a user is using a word processor application but is working on more than one document, the computer instructions can include instructions for determining which document is currently being worked on by the user. In one embodiment, when the user toggles from document A to document B, the activity timer for document A will deactivate while the inactivity timer for document A simultaneously activates so that it may record the amount of time for which there has been no activity with respect to document A. In another embodiment, the activity timer for document A can continue simultaneously with the inactivity timer. Regardless of the embodiment used, when the user toggles to document B, the activity timer for document B will activate.

Therefore, the computer instructions, in at least on embodiment, include instructions for determining the duration of any period of inactivity that may not be billable to the client. Once the user closes the third party software, the computer program terminates both the activity and/or inactivity timers and the server 400 receives a notification that the third party program has been closed at 442. The server then receives the client identification information at 446. As discussed above, however, the server may receive client identification information before the third party application is closed. However, once the third party application is closed and the server may receive the total billable activity duration at 454. In order to calculate the total billable activity time, the computer program will determine the total duration of activity as well as the total duration of inactivity. In one embodiment, the add-on computer program will prompt the user to provide instruction as to whether the period of inactivity is billable at 450 and will receive instructions as to the billable nature at 452. In other embodiments, however, the add-on computer program will only provide such a request if the period of inactivity exceeds a predetermined amount of time, for example more than six minutes. If the period of inactivity does not exceed the predetermined amount of time, the period of inactivity will be added or otherwise included to the total duration of activity to determine the duration of billable activity time. As previously mentioned, the computer program may also deduct or otherwise omit any periods of inactivity from the total billable time without prompting the user for additional input as to the billable nature of the period of inactivity or may do so only if the period of inactivity exceeds a predetermined amount of time.

However, in the shown embodiment, the user is prompted to provide input as to the billable nature of the period of inactivity after requesting input and provides such input at 452. With that information, the computer program may then determine the total billable activity time and the server receives the total billable activity time at 454. As with previous embodiments, the computer software residing on the server will use the client identification information to receive the billing information associated with that particular client and will use the billing information and the billable activity duration to create a time entry for approval. At 456, the workstation 410 will receive the time entry so that the user may approve it. After receiving approval of the time entry, the server 400 receives the approved time entry at 458 and transmits the approved time entry to the server at 460. However, in alternate embodiments, the computer program may include instructions for allowing workstation to transmit the approved time entry directly to the invoicing server 404 without first transmitting it to the server 400.

With the approved time entry, the invoicing server can then create a pre-bill with one or more time entries and the server receives pre-bill from the invoicing server at 462. The work station receives the pre-bill for review by the user at 464. However, the computer program may include instructions for allowing the workstation to receive the pre-bill directly from the invoicing server. However, once the pre-bill has been approved, the server receives the approved pre-bill from the workstation at 466 and transmits the approved pre-bill to the invoicing server at 468. However, in alternate embodiments, the computer program may include instructions for transmitting the approved pre-bill from the workstation directly to the invoicing server. With the approved pre-bill, the invoicing server may create a final invoice at 470 that may be sent to the client for payment.

Referring now to FIG. 4c, in at least one embodiment, the add-on computer program includes instructions for receiving the billing information directly from the user when the billing information is not available from the server or the invoicing. server. As with the previous embodiments shown in FIGS. 4a and 4b, when a user opens a third party software 408, the computer program activates a timer so as to calculate the billable activity time. When the user closes the third party software, the computer program deactivates the activity timer and the server receives a notification that the third party software has been closed as 472. The workstation receives the billing information directly from the user at 474 upon determining that the billing information is not available from either the server or the invoicing server. One skilled in the art will recognize that the add-on computer program 410 may include instructions for receiving the billing information from the user after the third party application has been opened but before such application has been closed. In either case, once the workstation has received the billing information from the user at 476, the server receives the billing information from the third party application at 478.

As discussed in association with FIG. 4b, the computer program includes instructions for determining periods of inactivity with respect to the third party program through either a keystroke logger or the detection of toggling between different applications or different documents within a single application. In the shown embodiment, the computer program requests input from the user as to whether any period of inactivity detected is billable at 482. After receiving information regarding the billable nature of the inactivity at 484, the computer program calculates the total billable activity time and the server receives the total billable activity at 486. With the total billable activity duration and the billing information, the server may then create a time entry which can be received by the workstation for approval at 488.. Upon receiving approval of the time entry, the server receives the approved time entry at 490 and transmits the approved time entry to the invoice server at 492. However, the computer program may include instructions for allowing the workstation to transmit the approved time entry directly to the invoicing server rather than transmitting it first to the server.

The invoicing server may use the approved time entry to create a pre-bill with one or more entries associated with a particular client. The server receives the pre-bill at 494 and the workstation receives the pre-bill for review at 496. Again, the computer program may include instructions for allowing the workstation to retrieve the pre-bill for review directly from the invoicing server. After presenting the user with the pre-bill and receiving approval of the pre-bill, the server receives the approved pre-bill from the workstation at 497. The server than transmits the approved pre-bill to the invoicing server at 498. However, the computer program may include instructions for allowing the workstation to transmit the approved pre-bill directly to the invoicing server without first having to transmit it to the server. With the approved pre-bill, the invoicing server may then create a final invoice at 499, which may then be sent to the client for payment.

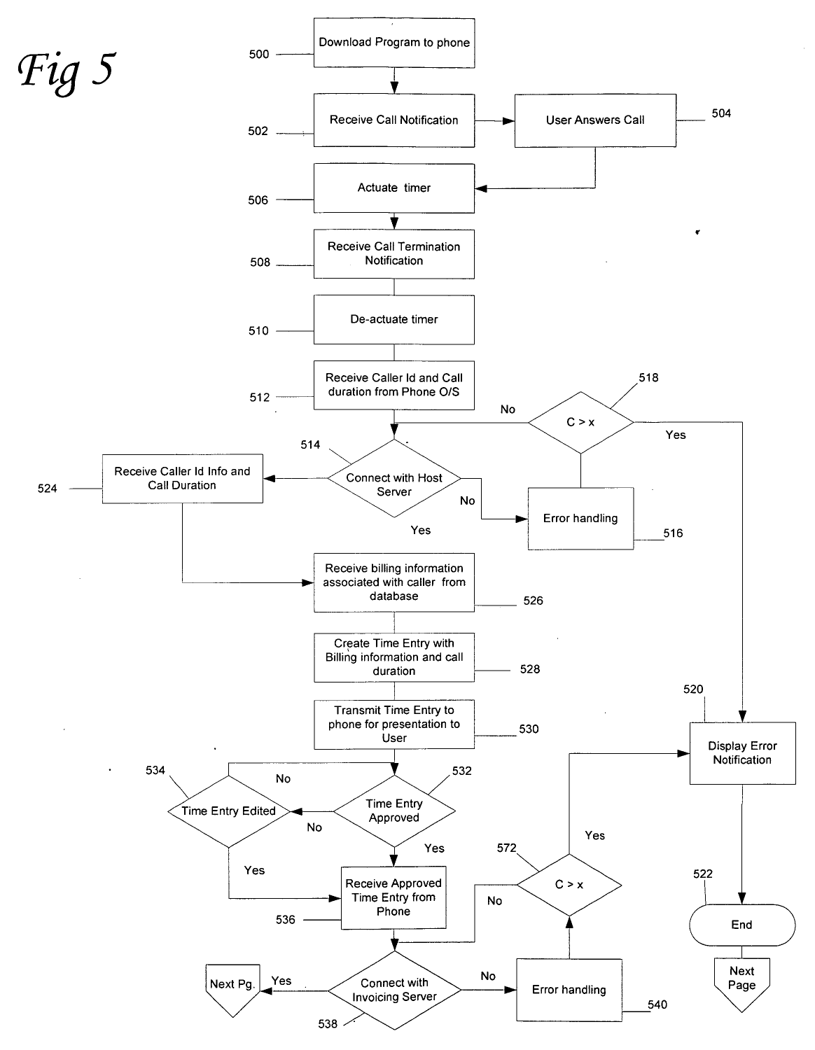

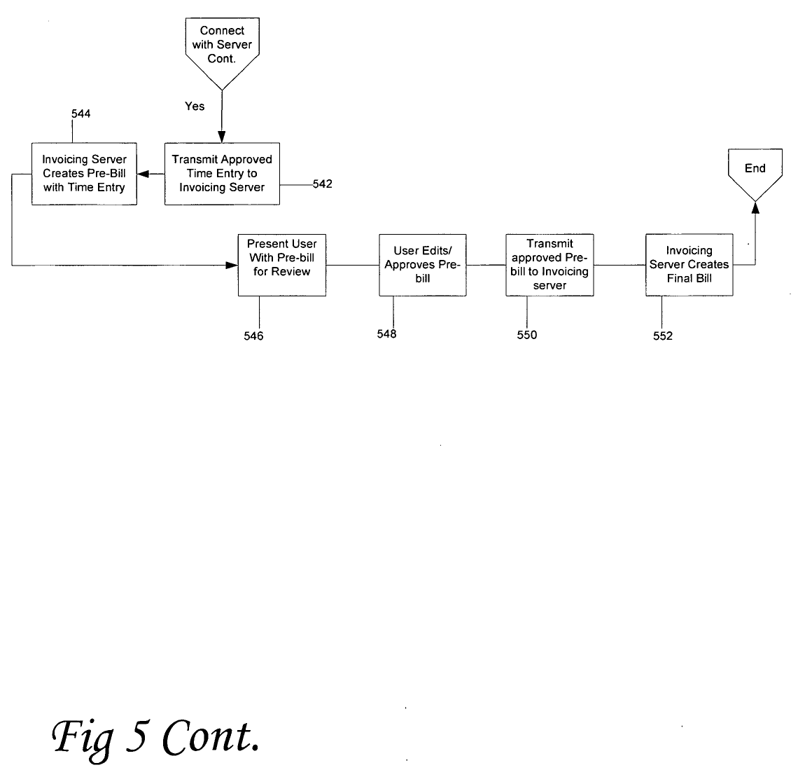

Referring now to FIG. 5, a flow-chart showing the operation of a first embodiment of the invention is further described. At 500, the add-on computer program must be downloaded to the PCD. At 502, the PCD receives a call notification in response to receiving a phone call. At 504, the user answers the phone, which in turn actuates the timer at 506. When the call is ended at 508, the timer is de-actuated at 510 at which point, the add-on computer program receives the caller identification and the call duration from the operating system of the PCD at 512. At 514, the PCD attempts to connect with the server containing the time capturing software. If the PCD is unable to connect with the server, it will note the inability to do so on a log at 516. At 518, the add-on computer program will determine whether the attempts to connect are greater than a predetermined number of attempts. If not, the software will continue to try to connect the PCD with the host server. If the count is greater than the predetermined number, the add-on computer software will prompt the PCD to display an error message at 520, at which point the program will end at 522 until such time that the connectivity problem can be cured.

If, however, the PCD is able to connect with the host server, the server will receive the caller identification and call duration from the add-on software at 524. At 526, the server will then receive the billing information associated with the caller by searching the database with the billing information. In at least one embodiment, the billing information in the database was received from the invoicing server. At 528, the computer program residing on the server will create a time entry according to the billing information and the call duration. At 530, the add-on software residing on the PCD will receive the time entry for presentation to the user for review. At 532, the add-on computer program will determine whether the time entry has been approved. If it has not been approved, it will determine whether the time entry has been edited at 534. If the time entry has not been edited, then the loop continues to determine whether the time entry has been approved or edited until such time that the user does approve or edit the time entry. If, however, the time entry has been edited at 534, or approved at 532, the server will receive the approved time entry at 536. At 538, the server will attempt to connect with the invoicing server. If the server is unable to connect to the invoicing server, the software will note the unsuccessful attempt to a log at 540 and at 542, will determine whether or not the unsuccessful attempts are greater than a predetermined number of attempts. If the unsuccessful attempts are greater than the predetermined number, the computer program will display an error notification at 520 which will end the program at 522 until the connectivity problem can be resolved.

If, however, the server is able to connect with the invoicing server at 538, the server will transmit the approved time entry to the invoicing server at 542. As discussed above with respect to FIG. 2, the computer program may include instructions that allow the PCD to receive and transmit information directly to and from the invoicing server. In any case, however, the invoicing server will create a pre-bill according to one or more approved time entries and at 546 the pre-bill will be presented to the user for review. At 548, the user will approve the pre-bill and at 550, the approved pre-bill will be transmitted to the invoicing server. At 552, the invoicing server will create a final pre-bill which will terminate the operation of the system.

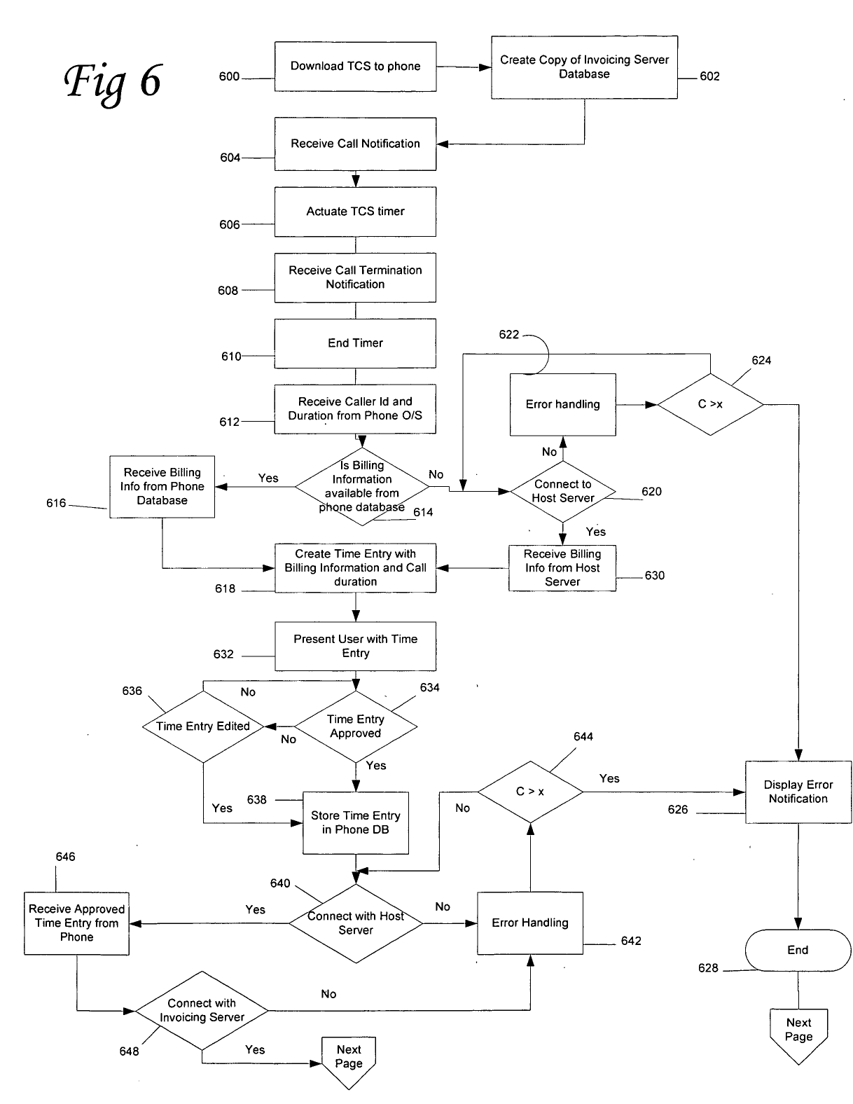

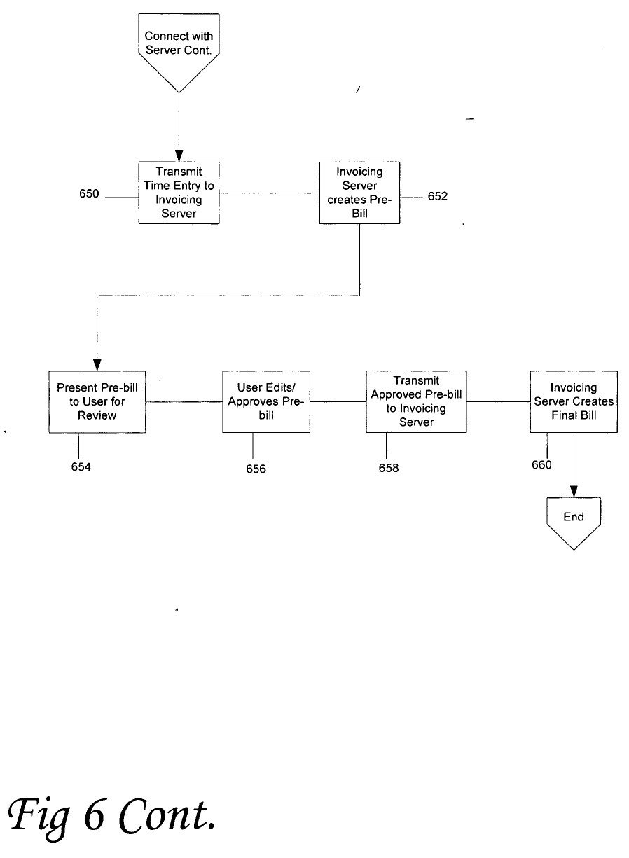

Referring now to FIG. 6, the operation of a further embodiment of the invention will be described. At 600, the add-on computer program must be downloaded to the PCD and at 602, the PCD receives billing information from the invoicing server and/or the server, which will be used to create a database of the billing information on the PCD. At 604, the phone receives a call notification in response to the initiation of a phone call, which causes the timer to be actuated at 606. At 608, the phone will receive a call termination notification in response to the termination of the phone call, which causes the timer to be terminated at 610. At 612, the add-on computer program will obtain the caller identification and call duration information from the PCD and at 614, the add-on computer program will determine whether the billing information associated with the caller is available from the database residing on the PCD. If the billing information is available from the database residing on the PCD, the add-on computer program will receive the billing information associated with the caller at 616 and will create a time entry with the billing information and call duration at 618.

If, however, the billing is not available from the database residing on the PCD, the add-on computer program will attempt to connect with the server at 620. If unable to connect with the server, the add-on computer program will note the unsuccessful attempt on a log at 622 and at 624, will determine whether the number of unsuccessful attempts is greater than a predetermined number of attempts. If it is not, it will continue to attempt to connect with the server. However, if the number of unsuccessful attempts is greater than the predetermined number, the add-on computer program will cause an error message to be displayed at 626, which will end the program at 628, until such time that the connection problems can be resolved.

However, if the PCD is able to connect with the host server, the add-on computer software will receive the billing information from the server at 630. The add-on computer program will create a time entry according to the billing information and the call duration at 618. However, it should be noted that in alternate embodiments, when the billing information is unavailable from the database on the PCD, the PCD will connect to the host server and the host server will receive the caller identification and search the database residing on the server to receive the billing information associated with the caller. The server can then create a time entry according to the billing information and the call duration and transmit that time entry to the phone.

In either case, the add-on computer program receives the time entry and presents the user with the time entry at 632. At 634, the add-on computer program will determine whether or not the time entry has been approved. If it has not, the determination as to whether the time entry has been edited is made at 636. If the time entry has not been edited, then it will continue to determine if the time entry has been approved and/or edited until such time that the user actually approves or edits the time entry. Assuming, however, that the time entry has been edited at 636 or approved at 634, the add-on computer program will store the approved time entry in a database residing on the PCD at 638. At 640, the PCD will attempt to connect with the host server. If it is unable to connect with the host server, it will note the unsuccessful attempt on a log at 642, and at 644 a determination as to whether the number of unsuccessful attempts are greater than a predetermined number. If the unsuccessful attempts are less than the predetermined number, the PCD will continue to attempt to connect with the server until a successful connection is made or until the number of attempts is greater than the predetermined number, at which point an error message will be displayed at 626 and the program will be terminated until such time that the connection problems can be resolved.

Assuming that the phone is able to connect with the server at 640, the host server will receive the approved time entry from the phone at 646. At 648, the host server will attempt to connect with the invoicing server. If it is unable to do so, it will note the error on log at 642 and determine whether the number of unsuccessful attempts is greater than a predetermined number. If they are, then the error log will be displayed and the program will be terminated until such connection problems can be resolved. If, however, the number of unsuccessful attempts is less than the predetermined number, the host server will continue to attempt to connect with the invoicing server until a successful connection is made. At 650, the time entry will be transmitted to the invoicing server and at which point, the invoicing server will create a pre-bill according to the approved time entry at 652. At 654, the pre-bill will be presented to the user for review and at 656, the user will approve and/or edit the pre-bill. At 658, the approved pre-bill will be transmitted to the invoicing server at which point the invoicing server will create a final pre-bill at 660, which will complete the operation of the invention. As discussed above, the computer program may include instructions allowing the PCD to communicate directly with the invoicing server.

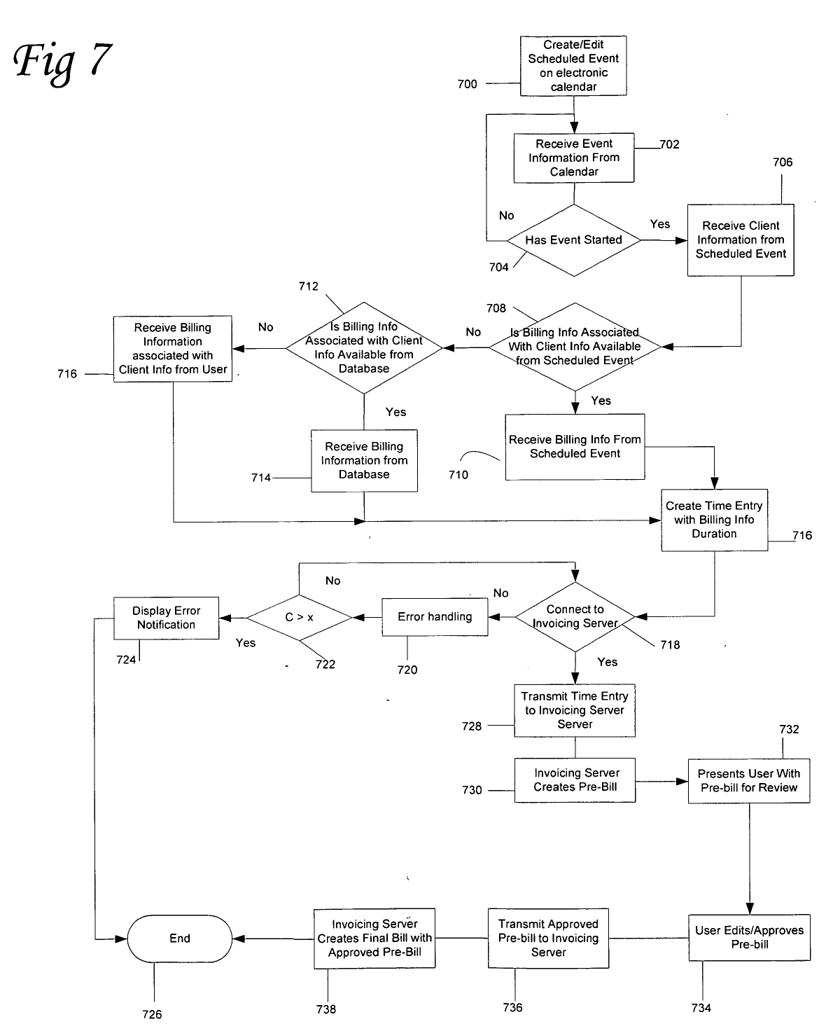

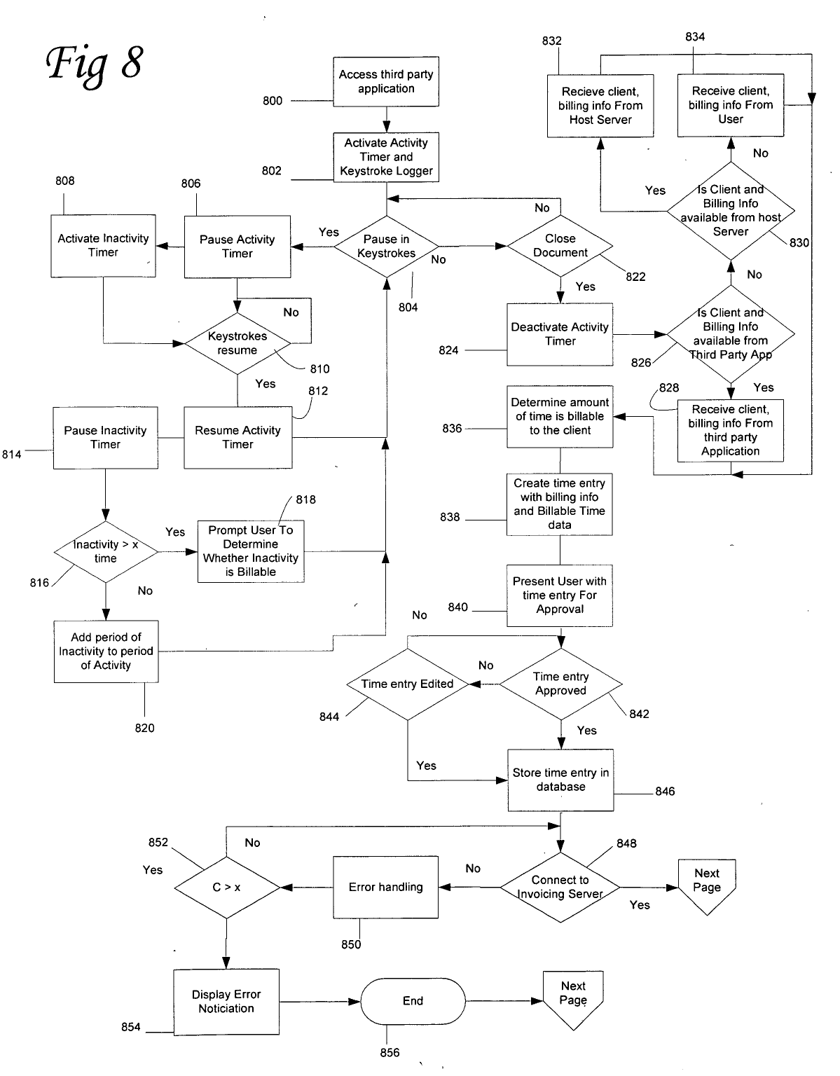

Referring now to FIG. 7, a flow-chart detailing the operation of a further embodiment is described. Specifically, this embodiment details the operation of the invention as it gathers information from an electronic calendar in order to automatically prepare a time entry which can be used to create a pre-bill and an invoice to be sent to the client. At 700, the user creates or edits a scheduled event on an electronic calendar. The computer software allows the workstation and/or server to communicate with the electronic calendar on a real-time basis, and, therefore, at 702, the computer program receives the event information from the electronic calendar. At 704, the software determines whether the event has started and if it has not, it continues to obtain the event information on a real-time basis from the electronic calendar.

If it is determined that the event has started at 704, the invention obtains the client information from the scheduled event at 706. At 708, the invention determines whether the billing information associated with the client is available from the scheduled event. If such billing information is available from the scheduled event, the program will receive the billing information from the scheduled event at 710. However, if the billing information is not available from the scheduled event, the invention will determine whether the billing information associated with the client is available from a database residing on the host server or the invoicing server at 712. If the billing information is available from either the host server or the invoicing server, the invention will obtain the billing information from one of the databases at 714. However, if the billing information is not available from either of the databases residing on the host or invoicing servers, the computer program will prompt the user to provide the billing information at 716.

Regardless of the source from which the program receives the billing information, the invention will automatically create a time entry with the billing information and the event duration at 716. At 718, the server and/or the workstation will attempt to connect with the invoicing server. If the server and/or workstation is unable to connect with the invoicing server at 718, the program will note the unsuccessful attempt on a log at 720 and will determine whether the number of unsuccessful events is greater than a predetermined number at 722. If the number of unsuccessful attempts is less than the predetermined number of attempts, then the server will continue to attempt to connect with the invoicing server until such time that a successful is made. If, however, the number of successful attempts is greater than the predetermined number of attempts, then an error notification will be displayed at 724 which will end the program until such time as the connection problem can be solved at 726.

Assuming, however, that the server and/or workstation is able to connect with the invoicing server at 718, the time entry will be transmitted to the invoicing server at 728 and the invoicing server will create a pre-bill according to one or more time entries at 730. At 732, the pre-bill will be presented to the user for review and at 734, the user will either edit or approve the pre-bill. At 736, the approved pre-bill will be transmitted to the invoicing server and at 738, the invoicing server may then create a final pre-bill, thus ending the program at 726.

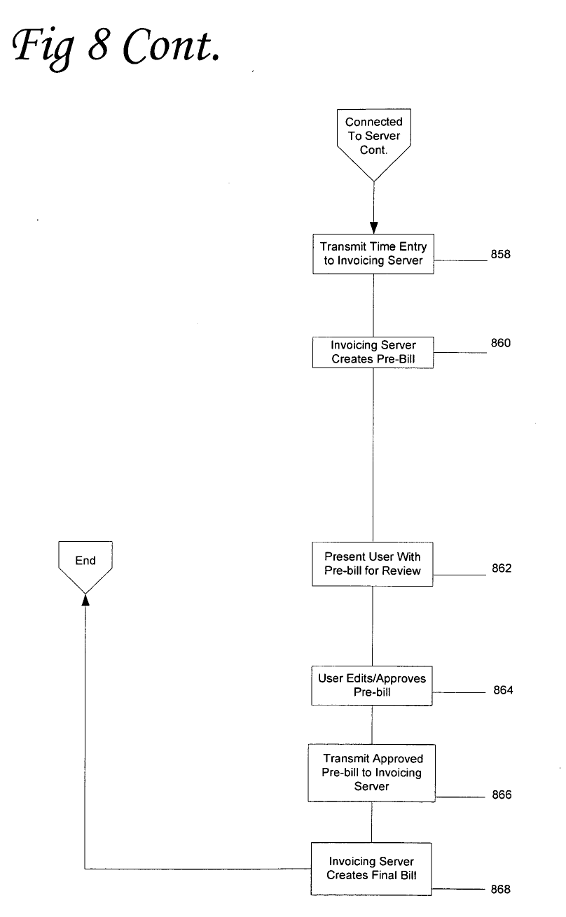

Referring now to FIG. 8, the flow-chart of the flow of operations for yet another embodiment of the invention is disclosed. In this embodiment, the invention allows a server and/or workstation to communicate with an invoicing server and a third party application such as an email application, a Word processing application or any other application that might be used during the provision of services to a client.

Turning now to the specifics of FIG. 8, the user accesses the third party application at 800, which in turn causes the software to activate a timer and in one embodiment a keystroke logger is also activated at 802. As described in association with FIG. 4, the timer and the keystroke logger allow the invention to determine the total billable activity time by calculating the period of activity as well as any period of inactivity and either including or omitting the period of inactivity in the total duration of billable activity. Therefore, at 804, the invention determines whether there is a pause in keystrokes. If so, the invention pauses the activity timer at 806 and simultaneously activates the inactivity timer at 808. As discussed above, however, in at least one embodiment, the activity timer does not pause upon the cessation of keystrokes. Instead, the cessation in keystrokes simply activates inactivity timer while keeping the activity timer actuated. At 810, the invention determines whether the keystrokes have resumed. If they have not, the loop continues until such time that the keystrokes have resumed. Once the keystrokes resume, the invention resumes the activity timer at 812 and simultaneously deactivates the inactivity timer at 814. However, in an alternate embodiment the resumed keystrokes simply deactivate the inactivity timer while not affecting the function of the activity timer.

In the shown embodiment, the invention then determines if the period of inactivity is greater than a predetermined time at 816. If it is, the invention prompts the user to provide input as to whether the period of inactivity should be billed to the client at 818. If, however, the period of activity is not greater than a predetermined amount of time, the invention then simply adds or otherwise includes the duration of inactivity to the current billable activity time at 820. This process continues for each time that there is a pause in keystrokes so that the invention may accurately keep track of the time that is to be billed to a client. In alternate embodiments, the keystroke logger can simply deduct or otherwise omit any duration of inactivity that exceeds a predetermined time from the total billable activity time without prompting the user for any additional input or it may simply deduct all periods of inactivity from the total billable activity time.

Assuming that no additional pauses in keystrokes occur, the invention determines whether or not the user has closed the third party application at 822. If it has not, it continues to determine whether there are any pauses in keystrokes until such time that the document is closed by the user. Once the document is closed at 822, the invention deactivates the activity and/or inactivity timer at 824, at which point the invention determines whether the client information and/or billing information is available from the third party application at 826. If the client and/or billing information is available from the third party application, the invention will receive the client and/or billing information from the third party application at 828.

If the client and/or billing information is not available from the third party application, the invention will then determine whether the client and/or the billing information is available from the host server at 830. If the client and/or billing information is available from the host server, the invention will then receive such client and/or billing information from the host server at 832. However, if the client and/or billing information is not available from the host server, the invention will prompt the user to provide the client and/or billing information at 834. Regardless of the source from which the invention receives the client and/or billing information, the invention will then determine total amount of billable activity time at 836. At 838, the invention will create the time entry according to the billing information and the billable activity time information. Once the time entry has been created, it will be presented to the user for approval at 840 and at 842, the invention will determine whether the time entry has been approved. If it has not, the invention will determine at 844, whether the time entry has been edited. If the time has neither been approved nor edited, the loop will continue until such time that the user edits or approves to the time entry.

Assuming, however, that the time entry is approved at 842 or edited at 844, the invention will then store the time entry in a database residing on the workstation or host server at 846. At 848, the server or workstation will attempt to connect with the invoicing server. If unable to connect with the invoicing server, the invention will log the unsuccessful attempt to a log at 850. At 852, the invention will determine whether the number of unsuccessful attempts is greater than a predetermined number of attempts. If it is not, it will continue trying to connect to the invoicing server until such time that a successful connection is made. If, however, the number of unsuccessful attempts is greater than the predetermined number of attempts, then the invention will display an error notification at 854, which will end the program at 856 until such time that the connection problems can be resolved.

Assuming, however, that the server or workstation is able to connect with the invoicing server at 848, the time entry will be transmitted to the invoicing server at 858. With the time entry, the invoicing server will create a pre-bill at 860 and the user will be presented with the pre-bill for review at 862. The user will edit or approve the pre-bill at 864 and the approved pre-bill will be transmitted to the invoicing server at 866. Once the invoicing server receives the approved pre-bill, the invoicing server will create a final pre-bill at 868 which will terminate the program at 856.

While a preferred embodiment of the invention has been described using specific terms, such description is for illustrative purposes only, and it is to be understood that changes and variations may be made without departing from the spirit or scope of the following claims.

What is claimed is:

1. A time capturing system comprising:
an add-on computer program for being installed on a portable computing device that when executed by the portable computer device causes the portable computer device to perform the method of receiving a call initiation instruction from the portable computing device wherein, said call initiation instruction represents the initiation of a phone call, activating a timer upon receiving said call initiation instruction, receiving a call termination instruction from the portable computing device wherein said call termination instruction represents the termination of a phone call, deactivating said timer upon receiving said call termination instruction and determining the duration of the call;
a server having a database embodied in said server wherein, said database includes billing information for each of the user's clients, said server being in communication with the portable computing device and an invoicing server;
a server computer program installed in said server that when executed by said server causes said server to perform the method of receiving said billing information from the invoicing server and updating said database with said billing information, receiving caller identification information from the portable computing device wherein, said caller identification information represents the identification of a caller, receiving billing information associated with said caller identification information from said database, receiving said duration of the call from the portable computing device, creating a time entry according to said billing information associated with said client identification information and said duration of the call, and transmitting said time entry to the invoicing server;
whereby said time capturing system automatically creates said time entry tracking the time the user spends speaking to another individual via the portable computing device, thus, reducing the amount of time and human interaction necessary to create the time entry.

2. The system of claim 2 wherein, said add-on computer program performs the method of receiving said time entry from said server and presenting said time entry to the user on the portable computing device for review.

3. The system of claim 2 wherein:
said add-on computer program performs the method of receiving an approval of said time entry; and,
said server computer program performs the method of receiving said time entry from the portable computing device upon approval and transmitting said time entry to the invoicing server.

4. The system of claim 1 wherein:
said server computer program performs the method of receiving a pre-bill from the invoicing server and transmitting said pre-bill to said portable computing device; and,
said add-on computer program performs the method of receiving said pre-bill from said server and presenting said pre-bill to the user on the portable computing device for review.

5. The system of claim 4 wherein:
said add-on computer program performs the method of receiving an approval of said pre-bill; and,
said server computer program performs the method of receiving said pre-bill from the portable computing device upon approval and sending said pre-bill to the invoicing server.

6. The system of claim 1 wherein:
said add-on computer program performs the method of creating a copy of said database and storing said copy of said database in said portable computing device; and,
said server computer program performs the method of receiving said billing information from one of said portable computing device and said database.

7. The system of claim 1 wherein, said add-on computer program performs the method of receiving an approval of said time entry from the user; and,
said server computer program performs the method of receiving said approved time entry from the portable computing device and sending said time entry to the invoicing server.

8. The system of claim 6 wherein, said server computer program performs the method of receiving billing information from the invoicing server when billing information is not retrievable from one of said portable computing device and said database.

9. A time capturing system comprising:
a server for communicating with an invoicing server and a workstation wherein, said workstation includes an electronic calendar;
a database embodied in said server wherein, said database includes billing information for each of the user's clients;
a server computer program installed in said server that when executed by said server causes the server to perform the method of receiving said billing information from the invoicing server and updating said database with said billing information, receiving event information from a scheduled event associated with the electronic calendar wherein, said event information includes a start time and an end time of a scheduled event and the subject of the scheduled event, determining whether said start time of the scheduled event has elapsed, receiving client information from the scheduled event, receiving billing information from said database according to said client information, creating a time entry according to said event information and said billing information associated with said client information, and transmitting said time entry to the invoicing server;
whereby said time capturing system automatically creates said time entry tracking the time spent by the user attending the scheduled event, thus, reducing the amount of time and human interaction necessary to create the time entry.

10. The system of claim 9 wherein, said client identification information represents information regarding the identity of the individuals attending the scheduled event.

11. The system of claim 9 wherein, said server computer program performs the method of receiving a pre-bill from the invoicing server and presenting the user with said pre-bill for review.

12. The system of claim 11 wherein, said server computer program performs the method of receiving an approval of said pre-bill from the user and transmitting said approved pre-bill to the invoicing server.

13. The system of claim 9 wherein, said server computer program performs the method of determining whether said billing information associated with said client information is available from the scheduled event, receiving said billing information associated with said client information if said information associated with said client information is available from the scheduled event and receiving said billing information associated with said client identification information from said database if said billing information associated with said client identification information is not available from the scheduled event.

14. The system of claim 13 wherein, said server computer program performs the method of determining whether said billing information associated with said client information is available from one of the scheduled event and said database and receiving said billing information associated with said client information from the user if said billing information associated with said client information is not available from one of the scheduled event and said database.

15. The system of claim 9 wherein, said server computer program performs the method of determining whether said billing information associated with said client information is available from the scheduled event and receiving said billing information associated with said client information from the user if said billing information associated with said client information is not available from said scheduled event.

16. A time capturing system comprising:
a server in communication with a third party computer program and an invoicing server and having a database embodied in said server, wherein said database includes billing information for each of the user's clients;
a server computer program installed on said server that when executed by said server causes said server to perform the method of receiving said billing information from the invoicing server and updating said database with said billing information, activating a timer upon accessing the third party computer program, detecting when user activity begins with respect to the third party computer program, detecting when user activity has ceased with respect to the third party computer program, determining an elapsed time during which user activity began and ceased with respect to the third party computer program, receiving client identification information from the third party computer program, receiving billing information associated with said client identification information from the third computer program, creating a time entry according to said elapsed time and said billing information associated with said client identification information, and transmitting said time entry to the invoicing server; and,
whereby said time capturing system automatically creates said time entry, reducing the amount of time and human intervention necessary to prepare said time entry.

17. The system of claim 16 wherein, said server computer program performs the method of receiving instruction from the user as to whether said elapsed time during which user activity had ceased with respect to the third party computer program should be billed to a client and modifying said elapsed time during which user activity had ceased.

18. The system of claim 16 wherein, said server computer program performs the method of receiving a pre-bill from the invoicing server and presenting the user with said pre-bill for review.

19. The system of claim 18 wherein, said server computer program performs the method of receiving an approval of said pre-bill from the user and transmitting said approved pre-bill to the invoicing server.

20. The system of claim 16 wherein, said server computer program performs the method of determining whether said billing information associated with said client identification information is available from the third party computer program, receiving said billing information associated with said client identification information from the third party computer program if said billing information associated with said client identification information is available from the third party computer program and receiving said billing information associated with said client identification information from said database if said billing information associated with said client identification information is not available from the third party computer program.

21. The system of claim 20 wherein, said server computer program performs the method of determining whether said billing information associated with said client identification information is available from one of the third party computer program and said database and receiving said billing information associated with said client identification information from the user if said billing information associated with said client identification information is not available from one of the third party computer program and said database.

22. The system of claim 16 wherein, said server computer program performs the method of determining whether said billing information associated with said client identification information is available from the third party computer program and receiving said billing information associated with said client identification information from the user if said billing information associated with said client identification information is not available from said third party computer program.

23. A time capturing system comprising:
a server having a database embodied in said server wherein, said database includes billing information for each of the user's clients, said server being in communication with a telephone system interconnected by a network and an invoicing server;
a server computer program installed in said server that when executed by said server causes said server to perform the method of receiving said billing information from the invoicing server and updating said database with said billing information, receiving caller identification information from the telephone system wherein, said caller identification information represents the identification of a caller, receiving billing information associated with said caller identification information from said database, receiving said duration of the call from the telephone system, creating a time entry according to said billing information associated with said client identification information and said duration of the call, and transmitting said time entry to the invoicing server;
whereby said time capturing system automatically creates said time entry tracking the time the user spends speaking to another individual via the telephone system, thus, reducing the amount of time and human interaction necessary to create the time entry.

24. The system of claim 23 wherein, the telephone system includes a private branch exchange is connected to the network and said server computer program causes said server to perform the method of receiving said billing information from the invoicing server and updating said database with said billing information, receiving caller identification information from the private branch exchange, wherein said caller identification information represents the identification of a caller.

25. The system of claim 23 wherein, the telephone system includes a call management server having call management software connected to the network and said server computer program causes said server to perform the method of receiving said billing information from the invoicing server and updating said database with said billing information, receiving caller identification information from the call management server, wherein, said caller identification information represents the identification of a caller.
